(19) United States
(12) Patent Application Publication
(10) Pub. No.: US 2026/0267675 A1
(43) Pub. Date: Sep. 10, 2026

(54) CONTAINER ORCHESTRATION SYSTEM WITH DYNAMICALLY ADJUSTABLE NODE CAPACITY

(71) Applicant: Microsoft Technology Licensing, LLC, Redmond, WA (US)

(72) Inventors: Nathan Erik WOHLGEMUTH, Redmond, WA (US); Sayan Dev PATHAK, Kirkland, WA (US); Michael Peter SINZ, Duvall, WA (US); Zoltan ROMOCSA, Kenmore, WA (US); Christopher Hakan BASOGLU, Everett, WA (US)

(21) Appl. No.: 19/073,978

(22) Filed: Mar. 7, 2025

(51) Int. Cl. G06F 9/455

(52) U.S. Cl. CPC G06F 9/45558; G06F 2009/45562; G06F 2009/45591

(57) ABSTRACT

A Kubernetes cluster is a set of nodes networked together. Each node has a fixed capacity of allocatable resources. When a workload is deployed onto a Kubernetes cluster, one or more pods are created. To use the resources, a pod can specify a quantity of resources it needs to do its work. Implicit in this work allocation scheme is that nodes are capable of performing up to their rated capacity. However, this assumption is not always true as there may be differences across the nodes that are not evident from their rated capacity. In some applications that are particularly sensitive to latency, these differences in execution time may not be acceptable. The presently disclosed technology monitors for nodes that are performing outside of a normal range and assigning compensator workload pods to compensate for underperforming nodes and/or assigning fewer compensator workload pods to compensate for overperforming nodes.

### BACKGROUND

Kubernetes is an open-source container orchestration system for automating software deployment, scaling, and management. Kubernetes organizes one or more computers, either virtual machines or bare metal, into a cluster which can run workloads in containers. Kubernetes'suitability for running and managing workloads of a variety of sizes and styles has led to its widespread adoption in clouds and data centers. There are multiple distributions of this platform, from independent software vendors (ISVs) to hosted-on-cloud offerings from major public cloud vendors.

### SUMMARY

The presently disclosed technology includes a container orchestration cluster comprising a set of nodes to execute a set of pods, a control plane running a scheduler to schedule the pods on the nodes, an abnormal node detector to identify an underperforming node within the set of nodes, and a compensator pod generator to create a compensator pod within the set of pods assigned to the identified underperforming node. The compensator pod does not consume its assigned resources and is assigned a higher scheduling priority than other pods within the set of pods. The control plane schedules the compensator pod on the underperforming node.

The presently disclosed technology further includes a method of allocating compensator pod capacity within a container orchestration cluster. The method comprises scheduling pods within a set of pods to execute on nodes within a set of nodes, identifying an underperforming node within the set of nodes, creating a compensator pod within the set of pods assigned to the identified underperforming node, and scheduling the compensator pod on the underperforming node. The compensator pod does not consume its assigned resources and is assigned a higher scheduling priority than other pods within the set of pods.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example container orchestration cluster with dynamically adjustable node capacity according to the disclosed technology.

FIG. 2 illustrates an example placement of a compensator pod in an underperforming node of a container orchestration cluster with dynamically adjustable node capacity.

FIG. 3 illustrates example placements of compensator pods in normal and abnormal nodes of a container orchestration cluster with dynamically adjustable node capacity.

FIG. 4 illustrates example operations for dynamically allocating compensator pod capacity within a container orchestration cluster according to the disclosed technology.

FIG. 5 illustrates an example schematic of a processing device suitable for implementing aspects of the disclosed technology.

### DETAILED DESCRIPTION

A Kubernetes cluster is a set of nodes networked together. Each node has a fixed capacity of allocatable resources. The resources include but are not limited to bytes of memory and central processing unit (CPU) cores. When a workload is deployed onto a Kubernetes cluster, one or more pods are created. To use the resources, a pod can specify a quantity of resources it needs to do its work. Implicit in this work allocation scheme is that a CPU core on one node is just as capable of doing work as any CPU core on any other node.

However, this assumption is not always true. A CPU works by executing instructions. The quantity of instructions a CPU can execute is, in part, controlled by its clock rate. The clock rate is generally the number of instructions that can be executed in a period of time. While a CPU may be rated at a specific clock rate, the clock rate can be dynamically raised or lowered by the CPU. For example, if the CPU is running at too high a temperature, the CPU may lower its clock rate to reduce the risk of thermal damage. The root cause of this reduced clock rate could be improper CPU cooling or a bad temperature sensor, for example, but regardless the CPU's clock rate is reduced below its rated capacity. Further, due to manufacturing differences and tolerances, as well as age of the equipment, the actual clock rate of a node naturally varies from its rated clock rate. This may also change over time. As a result, CPU performance per node in a Kubernetes cluster is not guaranteed to be the same across the connected CPU cores.

For many workloads, a difference in CPU performance between nodes does not cause problems as the workloads are sized such that they have more than enough resources or the workload can tolerate significant differences in execution time. However, in some applications that are particularly sensitive to latency, such as human interactivity (e.g., audio or videoconferencing, live captioning, live gaming, and life critical functions, such as self-driving automobile control), these differences in execution time may not be acceptable. For example, Microsoft Teams Live Captions is an accessibility feature for Microsoft Teams. Users who rely on the output of Teams Live Captions are significantly negatively impacted by delays in captions appearing on their screen. If the delay is significant enough, it may prevent users from participating effectively in a meeting.

The presently disclosed technology addresses and resolves these, and other issues in the prior art by monitoring for nodes that are performing outside of a normal range and assigning compensator pods, which are pods that consume little to no resources but are allocated greater resources that correspond to a workload, to compensate for underperforming nodes. In some implementations, the presently disclosed technology may assign fewer compensator workload pods to compensate for overperforming nodes. While the presently disclosed technology is described above with specific reference to a Kubernetes clusters and will work in particular with Kubernetes container orchestration systems, it may be similarly applicable to any container orchestration system that executes workloads using pods executed on nodes connected together in a cluster.

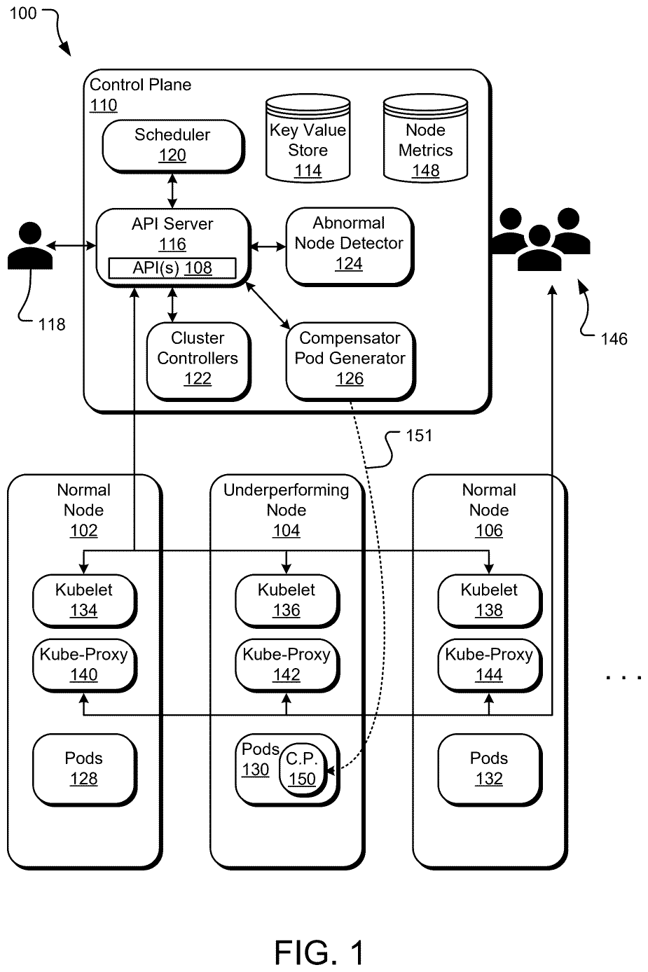

FIG. 1 illustrates an example container orchestration cluster 100 with dynamically adjustable node capacity according to the disclosed technology. The cluster 100 uses a set of mechanisms that deploy, maintain, and scale applications based on connected processing power and/or memory, or custom metrics. The internal components as well as extensions and containers within the cluster 100 rely on a cluster API (one of API(s) 108) executing within a control plane 110 to exert control over the connected compute and storage resources (e.g., that within nodes 102, 104, 106. collectively) by defining the connected resources as objects. The cluster API then manages the connected resources within the nodes 102, 104, 106 . . . , as a whole.

The components of the cluster 100 can be divided into those that are a part of an individual node and those that are part of the control plane 110. The three nodes 102, 104, 106, as well as all other nodes of the cluster 100, are communicatively coupled to one another and to the control plane 110 across a network, which may be a local area network, such as when the nodes physically reside in a same data center or small area, or a wide area network (e.g., the Internet), such as when the two or more nodes physically reside at geographically remote locations.

The control plane 110 manages the cluster 100 workload and directs communications across the connected nodes. The control plane 110 includes a variety of components performing a variety of functionalities. Key value store 114 (e.g., Etcd) is a persistent, lightweight, distributed, data store that reliably stores the configuration data of the cluster 100, representing the overall state of the cluster at any given point of time. API server 116 serves the API(s) 108, which provide both internal and external interfaces to the cluster 100. The API server 116 processes and validates requests, and updates the state of the objects in the key value store 114, thereby allowing an operator 118 to configure workloads and containers across the nodes.

The API server 116 may further use a metrics API (another of the API(s) 108) to track processing performance of each of the nodes (e.g., the nodes 102, 104, 106) connected to the cluster 100. Data collected by the metrics API may be stored in a node metrics datastore 148 and used by custom controllers (e.g., abnormal node detector 124 and compensator pod generator 126, each of which are discussed in detail below) to implement the presently disclosed technology.

The API server 116 may further use a watch API (another of the API(s) 108) to monitor the cluster 100, roll out configuration changes, or restore any divergences of the state of the cluster 100 back to a defined state per the key value store 114. As an example, the operator 118 may specify that three instances of a particular “pod” (described in further detail below) shall be running simultaneously, and the key value store 114 stores this rule. If the watch API finds that only two instances are running simultaneously (conflicting with the key value store 114 rule), the cluster API schedules the creation of an additional instance of that pod to run simultaneously with the two instances.

Scheduler 120 selects nodes on which unscheduled pods run based on resource availability and other constraints. The scheduler 120 tracks resource allocation on each node to ensure that workload is not scheduled in excess of available resources. For this purpose, the scheduler 120 knows the resource requirements, resource availability, and other user-provided constraints or policy directives such as quality-of-service, affinity/anti-affinity requirements, and data locality. In sum, the scheduler 120 matches resource “supply” to workload “demand”.

Cluster controllers 122 are reconciliation loops that drive the cluster 100 toward a desired state as defined by the key value store 114. The cluster controllers 122 communicate with the API server 116 to create, update, and delete the resources it manages (e.g., nodes and pods). The cluster 100 may support abstractions of workloads that are at a higher level than pods, such as ReplicaSets and DaemonSets. This allows the operator 118 to declaratively define and manage these high-level abstractions, instead of having to manage individual pods.

An example cluster controller is a ReplicaSet controller, which handles replication and scaling by running a specified number of copies of a pod across the cluster 100. The ReplicaSet controller also handles creating replacement pods if the underlying node fails. Other example cluster controllers are a DaemonSet controller for running X number of pods on every machine (or some subset of machines) and a Job controller for running pods that run to completion (e.g., as part of a batch job).

Custom controllers (e.g., abnormal node detector 124 and compensator pod generator 126, each of which are discussed in detail below) may also be installed within the control plane 110 or elsewhere in the cluster 100. These custom controllers further control the behavior of the API(s) 108 and the cluster 100 when used in conjunction with the cluster controllers 122. In some implementations, a controller manager may run as a single process that manages some or all of the cluster controllers 122 and the custom controllers, such as the examples provided above. In further implementations, the compensator pod generator 126 may utilize the DaemonSet controller (one of cluster controllers 122) to generate the compensator pods as directed by the compensator pod generator 126. In still further implementations, the compensator pod generator 126 may be one of the cluster controllers 122 that is instructed by the abnormal node detector 124 to generate compensator pods.

The three nodes 102, 104, 106 are examples of a full array of nodes connected to the cluster 100. The nodes are each discrete machines where containers (also referred to as workloads) are deployed. The basic scheduling unit of workloads in the cluster 100 is a pod (e.g., pods 128, 130, 132), each of which includes one or more containers that are co-located on the same node. Each pod is assigned a unique IP address within the cluster 100, allowing applications to use ports without the risk of conflict. One or more containers reside inside each pod. The container is the lowest level of a micro-service, which holds the running application, libraries, and their dependencies. All containers within a pod can reference each other. While the Kubernetes container orchestration systems generally uses pods to described units of workloads, other container orchestration systems may use other identifiers (including “workloads”) to describe similar concepts. Use of “pods” herein is intended to include both Kubernetes pods and similar workloads units in other container orchestration systems.

Kubelets 134, 136, 138 are responsible for the running state of their respective nodes 102, 104, 106, ensuring that all containers on the node are healthy. The Kubelets 134, 136, 138 start, stop, and maintain application containers organized into their assigned pods 128, 130, 132, respectively, as directed by the control plane 110. The Kubelets 134, 136, 138 also monitor the state of their assigned pods 128, 130, 132, respectively, and if not in the desired state, the pods 128, 130, 132 re-deploy to the same node. Node status is relayed every few seconds via heartbeat messages to the API server 116. If the control plane 110 detects a node failure, one of the cluster controllers 122 observes this state change and may launch the assigned pods on another healthy node.

Kube-proxies 140, 142, 144 are network proxies and load balancers for each of their respective nodes 102, 104, 106, and support service abstraction along with the other networking operations. The Kube-proxies 140, 142, 144 are responsible for routing traffic to the appropriate container based on IP and port number of an incoming request from one of users 146.

Custom controllers, such as the abnormal node detector 124 and the compensator pod generator 126, are extension mechanisms that interact with the cluster API(s) 108 to influence operation of the cluster 100. The abnormal node detector 124 runs in a loop by sequentially and repeatedly polling the node metrics datastore 148 for node-specific performance, updating a stored history of node performance (either within the node metrics datastore 148 or elsewhere), comparing each node's performance to one or more thresholds defining a normal node operation (e.g., +/−10% of rated clock speed), and labeling nodes that are abnormal. Node performance that is abnormal (e.g., greater than 10% variance from rated clock speed) may be referred to as an underperforming (running with a calculated clock speed below a 90% threshold of rated clock speed) or overperforming (running with a calculated clock speed above a 110% threshold of rated clock speed). The thresholds for abnormal node operations may be predetermined for the cluster 100, either for all uses of the abnormal node detector 124 or customizable by the operator 118 and/or the users 146.

In some implementations, abnormal node detector 124 limits the number of abnormal labels (e.g., underperforming or overperforming) that co-exist within the cluster 100 at a time. This prevents a possible overallocation of compensator pods within cluster 100, which could otherwise have the effect of reducing the overall capacity of the cluster 100.

The abnormal node detector 124 does not directly measure node performance but instead uses executing vs. idle time as a proxy for node performance. To accomplish this, the abnormal node detector 124 periodically monitors CPU performance of each node by querying node metrics datastore 148, either directly or through the API(s) 108. The node metrics datastore 148 returns data that reflects the time that each connected node spent time executing instructions and/or idled. The abnormal node detector 124 uses this information is used to create a history of each node's performance. As each node is assigned roughly the same amount of work (e.g., a quantity of pods) via the scheduler 120, any differences in node performance can be attributed to differences in the nodes themselves, rather than the assigned workloads. After a certain amount of history has been obtained for a given node, the abnormal node detector 124 computes an average CPU utilization of the node. If this computed value is outside of a configurable range or above/below a configurable threshold, the abnormal node detector 124 adds a label through the API(s) 108 to indicate that the node is running abnormally (e.g., underperforming node 104).

Daemon sets are cluster controllers 122 running in the background that ensure pods are created on all nodes in the cluster 100. Most workloads scale in response to a desired replica count for the pods, depending on the availability of the nodes and performance requirements of the pods, which yields pods on all nodes within the cluster 100. However, in some scenarios, a daemon set may deploy a pod to every single node in the cluster 100, scaling up the number of total pods as nodes are added and garbage collecting the nodes as they are removed from the cluster 100.

The compensator pod generator 126 is a unique daemon set that functions differently than other daemon sets running within the cluster 100. First, the pods the compensator pod generator 126 creates do little to no work. These pods are referred to herein as compensator pods. The compensator pods request resources of their nodes that the compensator pods make little to no use of. The compensator pods also have a higher scheduling priority than the scheduling priority of some or all of the normal workload pods. Other pods (e.g., telemetry gathering and security) may have an even higher scheduling priority than the compensator pods. The end result is that the compensator pods are processed by the nodes prior to some or all of the normal workload pods, but not before other higher priority pods.

For nodes that are labeled as underperforming (e.g., underperforming node 104), the compensator pod generator 126 assigns one or more compensator pods (e.g., compensator pod (C.P) 150) to that node, as illustrated by dotted arrow 151. The scheduler 120 treats the compensator pods as any other pods and schedules the compensator pods to the underperforming node(s) with high priority via the API(s) 108. The net effect of this is that when a node is labeled as underperforming, the compensator pods are immediately scheduled on that node and displace one or more typical workload pods. This dynamically reduces the effective assigned workload of the underperforming node (e.g., underperforming node 104) without affecting the work distribution to normal nodes (e.g., nodes 102, 106).

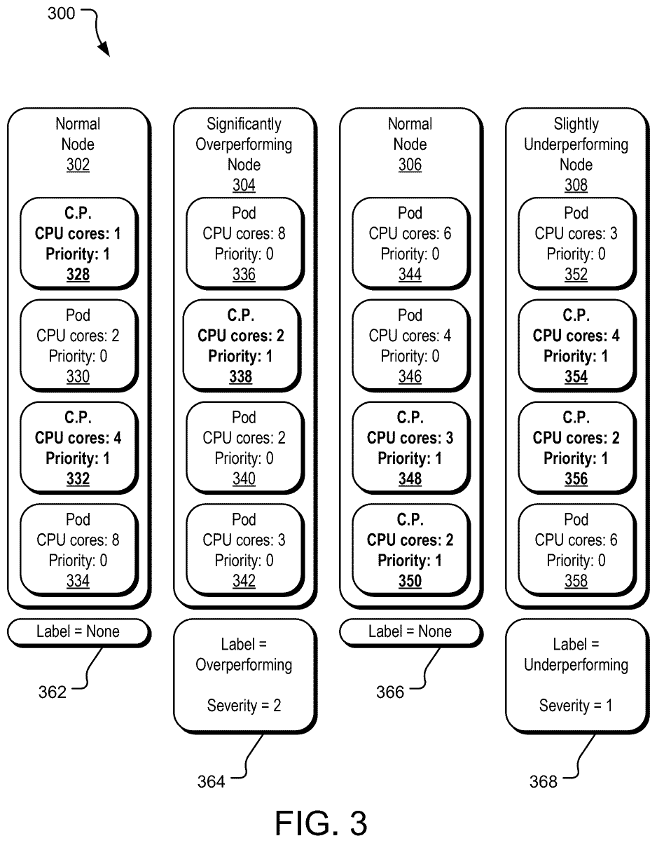

Similarly, for nodes that are labeled as overperforming (not shown, see e.g., overperforming node 304 of FIG. 3), the compensator pod generator 126 assigns one or more compensator pods to all nodes within the cluster 100, but comparatively fewer compensator pods to the overperforming node. The net effect of this is that when a node is labeled as overperforming, its load of compensator pods is reduced, and therefore fewer typical workload pods are displaced. This dynamically increases the effective assigned workload of the overperforming node without affecting the work distribution to normal nodes.

A combination of the abnormal node detector 124 and the compensator pod generator 126 allows the cluster 100 to automatically and dynamically adjust the CPU capacity of each connected node to control for observed differences in node CPU performance. This effect can be achieved on a typical container orchestration cluster implementation without customization beyond the addition of the abnormal node detector 124 and the compensator pod generator 126 connected to the API server 116. That allows software services that run on the cluster 100 that are highly sensitive to CPU performance variation to avoid performance issues caused by underperforming nodes. This also allows for overperforming nodes to be better utilized. In both scenarios, the presently disclosed dynamically adjustable node capacity allows for better capacity utilization and/or better service level agreement (SLA) attainment for the cluster 100.

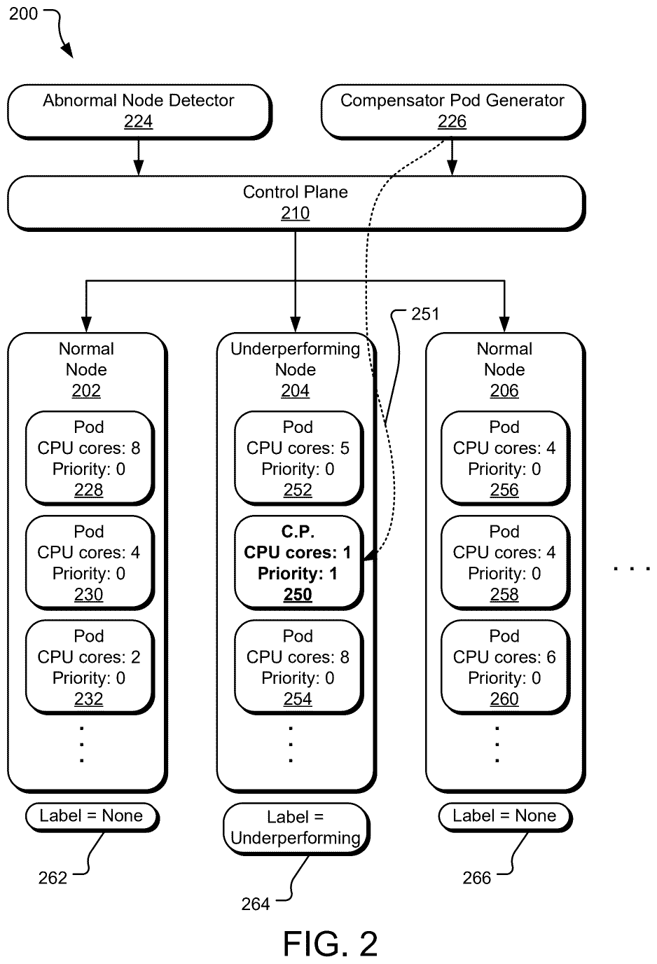

FIG. 2 illustrates an example placement of a compensator pod (C.P.) 250 in an underperforming node 204 of a container orchestration cluster 200 with dynamically adjustable node capacity. The cluster 200 relies on a cluster API (not shown, see e.g., API(s) 108 of FIG. 1) executing within a control plane 210 to exert control over the connected compute and storage resources (e.g., that within nodes 202, 204, 206. collectively) by defining the connected resources as objects. The cluster API then manages the connected resources within the nodes 102, 104, 106 . . . , as a whole.

The three nodes 202, 204, 206, as well as all other nodes of the cluster 200, are communicatively coupled to one another and to the control plane 210. The control plane 210 manages the cluster 200 workload and directs communications across the connected nodes. Custom controllers, such as abnormal node detector 224 and compensator pod generator 226, may also be installed within the control plane 210 or elsewhere in the cluster 200 (as shown in FIG. 2). These custom controllers further control the behavior of the cluster API and the cluster 200 when used in conjunction with other cluster controllers (not shown, see e.g., cluster controllers 122 of FIG. 1).

The three nodes 202, 204, 206 are examples of a full array of nodes connected to the cluster 200. The nodes are each discrete machines where containers (also referred to as workloads) are deployed. The basic scheduling unit of workloads in the cluster 200 is a pod, each of which includes one or more containers that are co-located on the same node. For example, pods 228, 230, 232 are co-located on node 202; pods 250, 252, 254 are co-located on node 204; and pods 256, 258, 260 are co-located on node 206.

The abnormal node detector 224 runs in a loop by sequentially and repeatedly polling a node metrics datastore (not shown, see e.g., node metrics datastore 148 of FIG. 1) for node-specific performance, updating a stored history of node performance (either within the node metrics datastore or elsewhere), comparing each node's performance to one or more thresholds defining a normal node operation (e.g., +/−10% of rated clock speed), and labeling nodes that are abnormal. Node performance that is abnormal (e.g., greater than 10% variance from rated clock speed) may be referred to as an underperforming (running with a calculated clock speed below a 90% threshold of rated clock speed) or overperforming (running with a calculated clock speed above a 110% threshold of rated clock speed).

The abnormal node detector 224 does not directly measure node performance but instead uses executing vs. idle time as a proxy for node performance. To accomplish this, the abnormal node detector 224 periodically monitors CPU performance of each node by querying the node metrics datastore, either directly or through the API(s). The node metrics datastore returns data that reflects the time that each connected node spent time executing instructions and/or idled. The abnormal node detector 224 uses this information is used to create a history of each node's performance.

As each node is assigned roughly the same amount of work (e.g., a quantity of pods) via the control plane (through a scheduler, not shown, see e.g., scheduler 120 of FIG. 1), any differences in node performance can be attributed to differences in the nodes themselves, rather than the assigned workloads. After a certain amount of history has been obtained for a given node, the abnormal node detector 224 computes an average CPU utilization of the node. If this computed value is outside of a configurable range or above/below a configurable threshold, the abnormal node detector 224 adds a label (e.g., labels 262, 264, 266) through the API(s) to indicate that the node's operational state referenced to a calculated “normal.” Abnormal nodes may be labeled as such, or specifically underperforming (e.g., underperforming node 204 is labeled “Underperforming”). Normal nodes 202, 206 are labeled “None” or lack any label at all.

The control plane 210 enables clients (e.g., operator 118 or internal components, such as the abnormal node detector 124 of FIG. 1) to attach keys called labels to any connected object in the cluster 100, such as pods and nodes. Correspondingly, label selectors, such as that used by compensator pod generator 226, are queries against the labels that resolve to matching objects. The labels of the nodes can then be used to control which nodes get assigned what pods. Other labels and label selectors that can be used depend on the object/resource type.

The control plane 210, using the scheduler, places the pods on the nodes according to a variety of rules that the scheduler considers for pod placement. In general, the pods are evenly distributed across the nodes to achieve an evenly distributed workload. For example, normal node 202 includes three assigned pods 228, 230, 232, which require 8, 4, and 2 CPU cores, respectively, to be processed. This results in a total work assignment of 14 CPU cores for node 202. Normal node 206 also includes three assigned pods 256, 258, 260, which require 4, 4, and 6 CPU cores, respectively, to be processed. This also results in a total work assignment of 14 CPU cores for node 206. While the individual pods may vary in terms of required processing power, the scheduler balances the overall workload between the nodes 202, 206. The number of pods per node, and CPU cores required to process the pods provided in FIG. 2 are illustrative examples only. Actual implementations of the cluster 200 would include vastly more nodes, pods, and perhaps additional variations on the processing power required by the pods, as well as additional performance requirements of the pods (e.g., memory space).

The compensator pod generator 226 is a unique daemon set that runs a label selector and creates pods that do little to no work (referred to herein as compensator pods) for labeled nodes. The compensator pods request resources of their nodes that the compensator pods make little to no use of. The compensator pods also have a higher scheduling priority than the scheduling priority of some or all of the normal workload pods. Other pods may have an even higher scheduling priority than the compensator pods.

For nodes that are labeled as underperforming (e.g., underperforming node 204), the compensator pod generator 226 assigns one or more compensator pods (e.g., the compensator pod 250) to that node, as illustrated by dotted arrow 251. The scheduler treats the compensator pods as any other pods and schedules the compensator pods to the underperforming node(s) with high priority. The net effect of this is that when a node is labeled as underperforming, the compensator pods are immediately scheduled on that node and displace one or more typical workload pods. This dynamically reduces the effective assigned workload of the underperforming node without affecting the work distribution to normal nodes (e.g., nodes 202, 206).

For example, underperforming node 204 includes three assigned pods 252, 250, 254, which require 5, 1 (allocated, but not used), and 8 CPU cores, respectively, to be processed. This results in a total work assignment of 14 CPU cores for underperforming node 204. However, as the abnormal node detector 224 previously determined that the node 204 is underperforming and labeled node 204 as such via label 264, one of the assigned pods for node 204 is a compensator pod 250 generated by the compensator pod generator 226 and assigned to the node 204. The compensator pod 250 carries a CPU core requirement of 1 but will actually consume 0 cores when assigned to the node 204. Further, the compensator pod 250 carries a priority label of “1,” which exceeds the other priority labels of “0” of the other pods 252, 254 assigned to the node 204. As a result, the node 204 processes the compensator pod 250 first, and while it is expected to consume 1 CPU core, it consumes no CPU cores. While only priority labels of “0” and “1” are shown in FIG. 2 and described in detail above, different or additional priority labels are contemplated herein to further differentiate a priority hierarchy of the compensator pods within all other pods.

Therefore, while all of nodes 202, 204, 206 have a total work assignment of 14 CPU cores as perceived by the scheduler, but in reality, only nodes 202, 206 actually process 14 CPU cores worth of work. Underperforming node 204 only processes 13 CPU cores worth of work. The resulting lighter workload of the underperforming node 204 allows it to catch up to normal nodes 202, 206 in terms of executing vs. idle time, as detected by the abnormal node detector 224. The abnormal node detector 224 and the compensator pod generator 226 perform their respective functions in a continuous loop, so that the effective workload of abnormal nodes is modified to yield a similar executing vs. idle time of the normal nodes. A combination of the abnormal node detector 224 and the compensator pod generator 226 allows the cluster 200 to automatically and dynamically adjust the CPU capacity of each connected node to control for observed differences in node CPU performance.

FIG. 3 illustrates example placements of compensator pods (C.P. s) in normal nodes 302, 306 and abnormal nodes 304, 308 of a container orchestration cluster 300 with dynamically adjustable node capacity. The cluster 300 relies on a cluster API (not shown, see e.g., API(s) 108 of FIG. 1) executing within a control plane (not shown, see e.g., control plane 210 of FIG. 2) to exert control over the connected compute and storage resources (e.g., that within nodes 302, 304, 306, 308 . . . , collectively) by defining the connected resources as objects. The cluster API then manages the connected resources within the nodes 302, 304, 306, 308 . . . , as a whole.

The nodes 302, 304, 306, 308 are examples of a full array of nodes connected to the cluster 300. The nodes are each discrete machines where containers (also referred to as workloads) are deployed. For example, pods 328, 330, 332, 334 are co-located on node 302; pods 336, 338, 340, 342 are co-located on node 304; pods 344, 346, 348, 350 are co-located on node 306; and pods 352, 354, 356, 358 are co-located on node 308.

An abnormal node detector (not shown, see e.g., abnormal node detector 224 of FIG. 2) runs in a loop by sequentially and repeatedly polling a node metrics datastore (not shown, see e.g., node metrics datastore 148 of FIG. 1) for node-specific performance, updating a stored history of node performance (either within the node metrics datastore or elsewhere), comparing each node's performance to one or more thresholds defining a normal node operation (e.g., +/−10% of rated clock speed), and labeling nodes that are abnormal. Node performance that is abnormal (e.g., greater than 10% variance from rated clock speed) may be referred to as an underperforming (running with a calculated clock speed below a 90% threshold of rated clock speed) or overperforming (running with a calculated clock speed above a 110% threshold of rated clock speed).

The abnormal node detector does not directly measure node performance but instead uses executing vs. idle time as a proxy for node performance. To accomplish this, the abnormal node detector periodically monitors CPU performance of each node by querying the node metrics datastore, either directly or through the API(s). The node metrics datastore returns data that reflects the time that each connected node spent time executing instructions and/or idled. The abnormal node detector uses this information is used to create a history of each node's performance.

As each node is assigned roughly the same amount of work (e.g., a quantity of pods) via the control plane (through a scheduler, not shown, see e.g., scheduler 120 of FIG. 1), any differences in node performance can be attributed to differences in the nodes themselves, rather than the assigned workloads. After a certain amount of history has been obtained for a given node, the abnormal node detector computes an average CPU utilization of the node. If this computed value is outside of a configurable range or above/below a configurable threshold, the abnormal node detector adds a label (e.g., labels 362, 364, 366, 368) through the API(s) to indicate that the node's operational state referenced to a calculated “normal.” Abnormal nodes may be labeled as such, or overperforming/underperforming (e.g., overperforming node 304 is labeled “Overperforming” and underperforming node 308 is labeled “Underperforming”). Normal nodes 302, 306 are labeled “None” or lack any label at all.

In some implementations, the labels 362, 364, 366, 368 include a severity rating that allows for a finer grained control over allocatable node capacity. With the severity rating, slightly abnormal nodes may be distinguished from significantly abnormal nodes. With that distinction, application of compensator pods, as discussion below, may be varied depending on the node's severity rating. “Slightly” and “significantly” are only two examples of severity ratings. Other implementations may be different or a greater number of severity ratings. In FIG. 3, significantly overperforming node 304 is given a severity rating of 2, while slightly underperforming node 308 is given a severity rating of 1. In the example of FIG. 3, a larger severity rating indicates a greater deviation from the calculated “normal” as compared to a smaller severity rating.

In general, the pods are evenly distributed across the nodes to achieve an evenly distributed workload. For example, normal node 302 includes four assigned pods 328, 330, 332, 334, which require 1, 2, 4, and 8 CPU cores, respectively. This results in a total work assignment of 15 CPU cores for node 302, 5 of which are not processed. Normal node 306 also includes four assigned pods 344, 346, 348, 350, which require 6, 4, 3, and 2 CPU cores, respectively. This also results in a total work assignment of 15 CPU cores for node 206, 5 of which are not processed. While the individual pods may vary in terms of required processing power, the overall workload is balanced between the nodes 302, 306. The number of pods per node, and CPU cores required to process the pods provided in FIG. 3 are illustrative examples only. Actual implementations of the cluster 300 would include vastly more nodes, pods, and perhaps additional variations on the processing power required by the pods, as well as additional performance requirements of the pods (e.g., memory space).

The compensator pod generator (not shown, see e.g., compensator pod generator 226 of FIG. 2) is a unique daemon set that runs a label selector and creates compensator pods. The compensator pods request resources of their nodes that the compensator pods make little to no use of. The compensator pods also have a higher scheduling priority than the scheduling priority of some or all of the normal workload pods. Other pods may have an even higher scheduling priority than the compensator pods. As the cluster 300 includes normal, overperforming, and underperforming nodes, the compensator pod generator generates a baseline number of compensator pods to normal nodes. The scheduler treats the compensator pods as any other pods and schedules the compensator pods to the underperforming node(s) with high priority.

Here, normal node 302 includes two assigned compensator pods 328, 332, which appear to require 1 and 4 CPU cores, respectively, to be processed. This results in a total compensator work assignment of 5 CPU cores for normal node 302. Normal node 306 also includes two assigned compensator pods 348, 350, which require 3 and 2 CPU cores, respectively, to be processed. This also results in a total compensator work assignment of 5 CPU cores for node 306.

For nodes that are labeled as underperforming (e.g., underperforming node 308), the compensator pod generator assigns additional compensator pod CPU capacity that may or may not include additional compensator pods to that node. Similarly, for nodes that are labeled as overperforming (e.g., overperforming node), the compensator pod generator assigns less compensator pod CPU capacity that may or may not include fewer compensator pods to that node. This dynamically decreases the effective assigned workload of the underperforming node 308 and increases the effective assigned workload of the overperforming node 304, without significantly affecting the work distribution to the normal nodes 302, 306.

More specifically, slightly underperforming node 308 includes four assigned pods 352, 354, 356, 358 which require 3, 4, 2, and 6 CPU cores, respectively, to be processed. This results in a total work assignment of 15 CPU cores for slightly underperforming node 308. However, as the abnormal node detector previously determined that the node 308 is underperforming and labeled node 308 as such via label 368, the total compensator pod CPU capacity assigned to the slightly underperforming node 308 (6 CPU cores) is greater than the compensator pod CPU capacity assigned normal nodes 302, 306 (5CPU cores). As the severity rating of label 368 (“1”) indicates an only slightly underperforming node 308, only one additional CPU core of compensator capacity is assigned to the node 308.

The compensator pods 354, 356 assigned to node 308 carry CPU core requirements of 4 and 2, respectively, but will actually consume 0 CPU cores. Further, the compensator pods 354, 356 carry a priority label of “1,” which exceeds the other priority labels of “0” of the other pods 352, 358 assigned to the node 308. As a result, the node 308 processes the compensator pods 354, 356 first, and while they are expected to consume 6 CPU cores, they consume no CPU cores.

Significantly overperforming node 304 also includes four assigned pods 336, 338, 340, 342 which require 8, 2, 2, and 3 CPU cores, respectively, to be processed. This results in a total work assignment of 15 CPU cores for node 304. However, as the abnormal node detector previously determined that the node 304 is over performing and labeled node 304 as such via label 364, the total compensator pod CPU capacity assigned to the node 304 (2 CPU cores) is less than the compensator pod CPU capacity assigned normal nodes 302, 306 (5 CPU cores). As the severity rating of label 364 (“2”) indicates that node 304 is “significantly overperforming,” three fewer CPU cores of compensator capacity are assigned to node 304 as compared to the normal nodes 302, 306.

The compensator pod 338 assigned to node 304 carries a CPU core requirement of 2 but will actually consume 0 CPU cores. Further, the compensator pod 338 carries a priority label of “1,” which exceeds the other priority labels of “0” of the other pods 336, 340, 342 assigned to the node 304. As a result, the node 304 processes the compensator pod 338 first, and while it is expected to consume 2 CPU cores, it consumes no CPU cores. While only priority labels of “0” and “1” are shown in FIG. 2 and described in detail above, different or additional priority labels are contemplated herein to further differentiate a priority hierarchy of the compensator pods within all other pods.

Therefore, while all of nodes 302, 304, 306, 308 have a total work assignment of 15 CPU cores as perceived by the scheduler, but in reality, nodes 302, 304, 306, 308 actually process different quantities of work based on their assigned compensator pods. Specifically, normal nodes 302, 306 actually process 10 CPU cores worth of work, as 5 CPU cores are allocated to compensator pods. Slightly underperforming node 308 only processes 9 CPU cores worth of work. The resulting lighter workload of the node 308 allows it to catch up to normal nodes 302, 306 in terms of executing vs. idle time. Significantly overperforming node 304 processes 13 CPU cores worth of work. The resulting heavier workload of the node 304 increases the burden on the node 304, thereby allowing the normal nodes 302, 306 to catch up to it in terms of executing vs. idle time.

The foregoing severity ratings on labels 364, 368 of nodes 304, 308, respectively, allow for a finer grained control of controlling allocatable node capacity. To implement this, the presently disclosed technology allows for multiple compensator pod generators (e.g., compensator pod generator 226), each corresponding to a severity rating. Other implementations may allow a singular compensator pod generator to assign compensator pods depending on the severity rating. In some instances, the multiple compensator pod generators run sequentially, with a more aggressive assignment of compensator pods in each successive implementations of compensator pod generator.

The abnormal node detector and the compensator pod generator perform their respective functions in a continuous loop, so that the effective workload of abnormal nodes is modified to yield a similar executing vs. idle time of the normal nodes. However, in some instances, this may yield an overallocation of compensator pods within a cluster, which has the effect of reducing the overall capacity of the cluster. To avoid this possibility, the cluster 300 may implement a policy within the compensator pod generator(s) that limit the number of abnormal labels or compensator CPU capacity that may exist within the cluster 300 at any point in time. These limits may be useful to prevent a runaway condition where the cluster 300 is increasingly burdened with compensator pods over time.

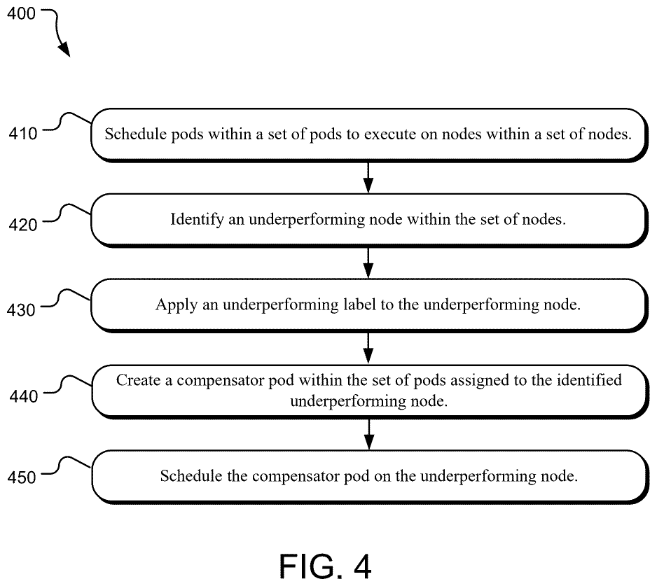

FIG. 4 illustrates example operations 400 for dynamically allocating compensator pod capacity within a Kubernetes cluster (or other container orchestration cluster) according to the disclosed technology. Kubernetes clusters assume that each node operates closely to its rated capacity. In instances where a node is not operating closely to its rated capacity (e.g., the node overheats and is throttling its performance to avoid failure), the node cannot keep up with its assigned workload. These are referred to herein generally as an abnormal node, and specifically in the case an underperforming node. This can cause latency issues across the Kubernetes cluster for any overall tasks that depend on output from the underperforming node. Prior art Kubernetes cluster installations lack the ability to detected abnormal node(s) and take corrective steps specific to the detected abnormal node(s). The presently disclosed technology, including operations 400, detects the abnormal node(s) and dynamically allocates compensator pod capacity to compensate for the abnormal node(s).

A scheduling operation 410 schedules pods within a set of pods to execute on nodes within a set of nodes. The scheduling operation 410 is performed by a scheduler run by a controller operating on a control plane connected to the set of nodes associated with the container orchestration cluster. The control plane controls overall operation of the container orchestration cluster.

An identifying operation 420 identifies an underperforming node within the set of nodes. The identifying operation 420 is performed by an abnormal node detector running on or connected to the control plane. The abnormal node detector does not directly measure node performance but instead uses executing vs. idle time as a proxy for node performance. As each node is assigned roughly the same amount of work (e.g., a quantity of pods), any differences in node performance can be attributed to differences in the nodes themselves, rather than the assigned workloads. After a certain amount of history has been obtained for a given node, the abnormal node detector computes an average CPU utilization of the node.

An applying operation 430 applies an underperforming label to the underperforming node. If the computed CPU utilization value is outside of a configurable range or above/below a configurable threshold, the abnormal node detector adds a label to indicate that the node is running abnormally (e.g., underperforming).

A creating operation 440 creates a compensator pod within the set of pods assigned to the identified underperforming node. The creating operation 440 is performed by a compensator pod generator running on or connected to the control plane. The compensator pod does not consume its assigned resources and is assigned a higher scheduling priority than some or all of the other pods within the set of pods. Other pods may have an even higher scheduling priority than the compensator pods.

A scheduling operation 450 schedules the compensator pod on the underperforming node. The scheduling operation 450 is performed by the scheduling, which treats the compensator pod as any other pod and the container orchestration cluster processes the compensator pod just as any other pod. However, the end result is a change of effective capacity of the node as the assigned compensator pods do not actually consume the resources that they are assigned. The abnormal node detector runs in a loop by sequentially and repeatedly polling the node metrics datastore and performing identifying and applying operations 420, 430 for abnormal nodes. The creating and scheduling operations 440, 450 also repeat as abnormal labels are applied to abnormal nodes within the container orchestration cluster.

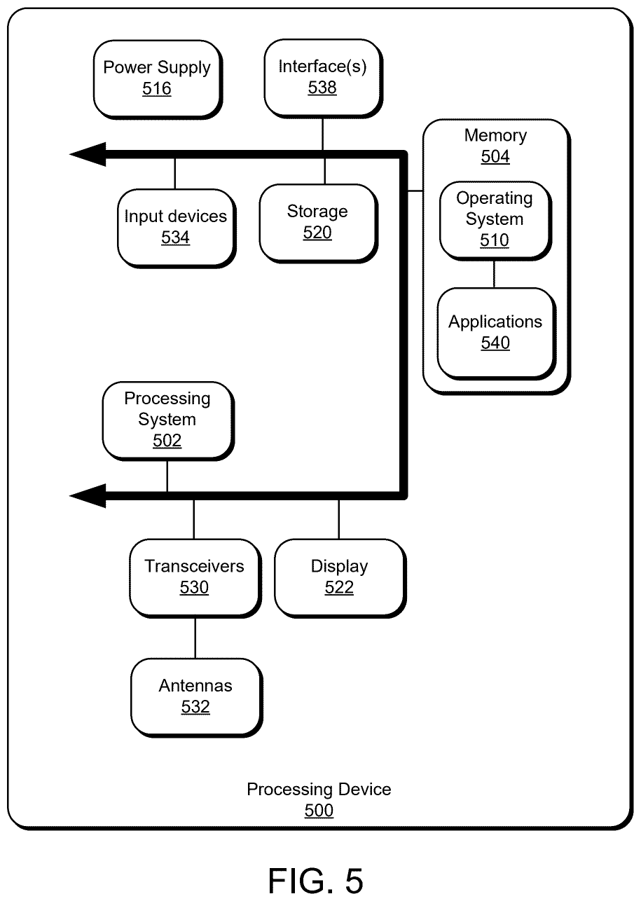

FIG. 5 illustrates an example schematic of a processing device 500 suitable for implementing aspects of the disclosed technology. The processing devices 500 includes one or more processor unit(s) 502, memory device(s) 504, a display 522, and other interfaces 538 (e.g., buttons). The processor unit(s) 502 may each include one or more CPUs, GPUs, etc.

The memory device(s) 504 generally includes both volatile memory (e.g., RAM) and non-volatile memory (e.g., flash memory). An operating system 510, such as the Microsoft Windows® operating system, the Microsoft Windows® Phone operating system or a specific operating system designed for a gaming device, may resides in the memory device(s) 504 and be executed by the processor unit(s) 502, although it should be understood that other operating systems may be employed.

One or more applications 540 (e.g., the discloses consensus algorithm logic) are loaded in the memory device(s) 504 and executed on the operating system 510 by the processor unit(s) 502. The applications 540 may receive inputs from one another as well as from various input local devices 534 such as a microphone, keypad, mouse, stylus, touchpad, gamepad, racing wheel, joystick, and camera. Additionally, the applications 540 may receive input from one or more remote devices, such as remotely located smart devices, by communicating with such devices over a wired or wireless network using more communication transceivers 530 and an antenna 532 to provide network connectivity (e.g., a mobile phone network, Wi-Fi®, Bluetooth®). The processing device 500 may also include one or more storage devices 520 (e.g., non-volatile storage). Other configurations may also be employed.

The processing device 500 further includes a power supply 516, which is powered by one or more batteries or other power sources, and which provides power to other components of the processing device 500. The power supply 516 may also be connected to an external power source (not shown) that overrides or recharges the built-in batteries or other power sources.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, RF, infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled and/or interpreted programming language.

Implementations described herein include a container orchestration cluster comprising a set of nodes to execute a set of pods, a control plane running a scheduler to schedule the pods on the nodes, an abnormal node detector to identify an underperforming node within the set of nodes, and a compensator pod generator to create a compensator pod within the set of pods assigned to the identified underperforming node. The compensator pod does not consume its assigned resources and is assigned a higher scheduling priority than other pods within the set of pods and the control plane is further to schedule the compensator pod on the underperforming node.

The abnormal node detector may further apply an underperforming label to the underperforming node.

The underperforming label may include a severity rating.

The underperforming node may be identified by determining that its idle time is below a predetermined normal threshold defined by other nodes within the set of nodes.

The abnormal node detector may poll the control plane for node performance and update a node metrics datastore with node-specific performance metrics.

The abnormal node detector may compare the node-specific performance metrics to identify the underperforming node within the set of nodes.

The abnormal node detector may further identify multiple underperforming nodes within the set of nodes; and the compensator pod generator may further create multiple compensator pods within the set of pods, at least one of which is assigned to each of the identified underperforming nodes. The compensator pods do not consume their assigned resources and the compensator pods are assigned a higher scheduling priority than other pods within the set of pods. The scheduler may further schedule the compensator pods on the underperforming nodes.

The abnormal node detector may further apply underperforming labels to the underperforming nodes and the abnormal node detector may limit a number of underperforming labels that co-exist within the container orchestration cluster at a time.

The abnormal node detector and the compensator pod generator may be connected to an API server within the control plane.

The abnormal node detector and the compensator pod generator may run outside of the control plane but are connected to an API server within the control plane.

Implementations described herein include a method of allocating compensator pod capacity within a container orchestration cluster. The method comprises scheduling pods within a set of pods to execute on nodes within a set of nodes, identifying an underperforming node within the set of nodes, and creating a compensator pod within the set of pods assigned to the identified underperforming node. The compensator pod does not consume its assigned resources and is assigned a higher scheduling priority than other pods within the set of pods. The method further comprises scheduling the compensator pod on the underperforming node.

The method may further comprise applying an underperforming label to the underperforming node.

Implementations described herein include a container orchestration cluster comprising a set of nodes to execute a set of pods, a control plane running a scheduler to schedule the pods on the nodes, an abnormal node detector to identify an abnormal node within the set of nodes, and a compensator pod generator to create compensator pods within the set of pods. The compensator pods do not consume their assigned resources and are assigned a higher priority than other pods within the set of pods and the control plane is further to schedule a different quantity of compensator pods on the abnormal node than normal nodes within the set of nodes.

The abnormal node detector may poll the control plane for node performance and update a node metrics datastore with node-specific performance metrics.

The abnormal node detector may compare the node-specific performance metrics to identify the abnormal node within the set of nodes.

The abnormal node may be identified as an overperforming node, and the control plane may further schedule fewer compensator pods on the overperforming node than the normal nodes within the set of nodes.

The abnormal node may be identified as an underperforming node, and the control plane may further schedule more compensator pods on the underperforming node than the normal nodes within the set of nodes.

The abnormal node may be identified as an underperforming node, and the control plane may further schedule compensator pods only on the underperforming node.

The abnormal node may be identified by determining that its idle time is outside of a predetermined normal range defined by other nodes within the set of nodes.

The abnormal node detector may further apply an abnormal label to the abnormal node.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Logical operations may be performed in any order, adding or omitting operations, unless explicitly claimed otherwise or a specific order is inherently necessitated by the claim language. The above specification, examples, and data, together with the attached appendices, provide a complete description of the structure and use of example implementations.

What is claimed is:

1. A container orchestration cluster comprising:
a set of nodes to execute a set of pods;
a control plane running a scheduler to schedule the pods on the nodes;
an abnormal node detector to identify an underperforming node within the set of nodes; and
a compensator pod generator to create a compensator pod within the set of pods assigned to the identified underperforming node, wherein the compensator pod does not consume its assigned resources and is assigned a higher scheduling priority than other pods within the set of pods, the control plane further to schedule the compensator pod on the underperforming node.

2. The container orchestration cluster of claim 1, wherein the abnormal node detector is further to apply an underperforming label to the underperforming node.

3. The container orchestration cluster of claim 2, wherein the underperforming label includes a severity rating.

4. The container orchestration cluster of claim 1, wherein the underperforming node is identified by determining that its idle time is below a predetermined normal threshold defined by other nodes within the set of nodes.

5. The container orchestration cluster of claim 1, wherein the abnormal node detector is to poll the control plane for node performance and updates a node metrics datastore with node-specific performance metrics.

6. The container orchestration cluster of claim 5, wherein the abnormal node detector is to compare the node-specific performance metrics to identify the underperforming node within the set of nodes.

7. The container orchestration cluster of claim 1, wherein the abnormal node detector is further to identify multiple underperforming nodes within the set of nodes; and the compensator pod generator is further to create multiple compensator pods within the set of pods, at least one of which is assigned to each of the identified underperforming nodes, wherein the compensator pods do not consume their assigned resources and the compensator pods are assigned a higher scheduling priority than other pods within the set of pods, the scheduler further to schedule the compensator pods on the underperforming nodes.

8. The container orchestration cluster of claim 7, wherein the abnormal node detector is further to apply underperforming labels to the underperforming nodes, and wherein the abnormal node detector limits a number of underperforming labels that co-exist within the container orchestration cluster at a time.

9. The container orchestration cluster of claim 1, wherein the abnormal node detector and the compensator pod generator are connected to an API server within the control plane.

10. The container orchestration cluster of claim 1, wherein the abnormal node detector and the compensator pod generator run outside of the control plane but are connected to an API server within the control plane.

11. A method of allocating compensator pod capacity within a container orchestration cluster comprising:
scheduling pods within a set of pods to execute on nodes within a set of nodes;
identifying an underperforming node within the set of nodes;
creating a compensator pod within the set of pods assigned to the identified underperforming node, wherein the compensator pod does not consume its assigned resources and is assigned a higher scheduling priority than other pods within the set of pods; and
scheduling the compensator pod on the underperforming node.

12. The method of claim 11, further comprising:
applying an underperforming label to the underperforming node.

13. A container orchestration cluster comprising:
a set of nodes to execute a set of pods;
a control plane running a scheduler to schedule the pods on the nodes;
an abnormal node detector to identify an abnormal node within the set of nodes;
a compensator pod generator to create compensator pods within the set of pods, wherein the compensator pods do not consume their assigned resources and are assigned a higher priority than other pods within the set of pods, the control plane further to schedule a different quantity of compensator pods on the abnormal node than normal nodes within the set of nodes.

14. The container orchestration cluster of claim 13, wherein the abnormal node detector is to poll the control plane for node performance and updates a node metrics datastore with node-specific performance metrics.

15. The container orchestration cluster of claim 14, wherein the abnormal node detector is to compare the node-specific performance metrics to identify the abnormal node within the set of nodes.

16. The container orchestration cluster of claim 13, wherein the abnormal node is identified as an overperforming node, and the control plane is further to schedule fewer compensator pods on the overperforming node than the normal nodes within the set of nodes.

17. The container orchestration cluster of claim 13, wherein the abnormal node is identified as an underperforming node, and the control plane is further to schedule more compensator pods on the underperforming node than the normal nodes within the set of nodes.

18. The container orchestration cluster of claim 13, wherein the abnormal node is identified as an underperforming node, and the control plane is further to schedule compensator pods only on the underperforming node.

19. The container orchestration cluster of claim 13, wherein the abnormal node is identified by determining that its idle time is outside of a predetermined normal range defined by other nodes within the set of nodes.

20. The container orchestration cluster of claim 13, wherein the abnormal node detector is further to apply an abnormal label to the abnormal node.
